(19) United States
(12) Patent Application Publication
(10) Pub. No.: US 2021/0081028 A1
(43) Pub. Date: Mar. 18, 2021

(54) Display Device And Mobile Terminal

(71) Applicant: Sony Corporation, Tokyo (JP)

(72) Inventor: Tsutomu Nagai, Tokyo (JP)

(73) Assignee: Sony Corporation, Tokyo (JP)

(21) Appl. No.: 16/760,612

(22) PCT Filed: Nov. 28, 2018
(86) PCT No.: PCT/JP2018/043682

§ 371 Date: Apr. 30, 2020

(30) Foreign Application Priority Data
Dec. 7, 2017 (JP) 2017-235530

(51) Int. Cl. G06F 3/01; G06F 3/16; G09G 5/373

(52) U.S. Cl. CPC G06F 3/011; G06F 3/165; G09G 2380/02; G09G 2354/00; G09G 5/373

(57) ABSTRACT

A display device according to an embodiment of the present disclosure includes: a display panel that is flexible; and a detector that is provided at an end edge of the display panel, and detects at least one of a bending operation, a pulling operation, or a pushing operation for the display panel. This display device further includes a controller that causes the display panel to display an image, and causes the display panel to perform any one of changing a channel of the image, turning up a sound volume, turning down the sound volume, muting, displaying a program guide, scaling up the image, scaling down the image, or displaying two screens, on the basis of a detection result obtained by the detector.

### TECHNICAL FIELD

The present disclosure relates to a display device and a mobile terminal.

### BACKGROUND ART

To date, a remote controller of a TV (television) set has been provided with dedicated buttons for performing changing a channel and changing a sound volume that represent the most common control. For example, PTL 1 describes a remote controller. In addition, for example, in a case of viewing TV broadcasts on a tablet terminal, changing a channel and changing a sound volume are performed using mechanical buttons provided on the terminal, buttons displayed on a screen of the terminal, or the like.

### CITATION LIST

### Patent Literature

PTL 1: Japanese Unexamined Patent Application Publication No. 2011-253493

### SUMMARY OF THE INVENTION

Incidentally, a new interface for performing changing a channel, changing a sound volume, and the like has been desired. Therefore, it is desirable to provide a display device and a mobile terminal that each include the new interface.

A display device according to an embodiment of the present disclosure includes: a display panel that is flexible; and a detector that is provided at an end edge of the display panel, and detects at least one of a bending operation, a pulling operation, or a pushing operation for the display panel. This display device further includes a controller that causes the display panel to display an image, and causes the display panel to perform any one of changing a channel of the image, turning up a sound volume, turning down the sound volume, muting, displaying a program guide, scaling up the image, scaling down the image, or displaying two screens, on the basis of a detection result obtained by the detector.

The display device according to the embodiment of the present disclosure allows for at least one of the bending operation, the pulling operation, or the pushing operation for the display panel, and the operation for the display panel is detected by the detector. Further, any one of changing the channel of the image, turning up the sound volume, turning down the sound volume, muting, displaying the program guide, scaling up the image, scaling down the image, or displaying two screens is performed by the display panel on the basis of the detection result obtained by the detector. In such a manner, in the present disclosure, changing the channel of the image and the like are performed in an operation method different from an existing operation method such as depressing of dedicated buttons.

A mobile terminal according to an embodiment of the present disclosure includes: a display panel that is flexible; and a detector that is provided at an end edge of the display panel, and detects at least one of a bending operation, a pulling operation, or a pushing operation for the display panel. This mobile terminal further includes a controller that causes the display panel to display an image, and causes an external device to perform any one of changing a channel of the image, turning up a sound volume, turning down the sound volume, muting, displaying a program guide, scaling up the image, scaling down the image, or displaying two screens, on the basis of a detection result obtained by the detector.

The mobile terminal according to the embodiment of the present disclosure allows for at least one of the bending operation, the pulling operation, or the pushing operation for the display panel, and the operation for the display panel is detected by the detector. Further, any one of changing the channel of the image, turning up the sound volume, turning down the sound volume, muting, displaying the program guide, scaling up the image, scaling down the image, or displaying two screens is performed by the external device on the basis of the detection result obtained by the detector. In such a manner, in the present disclosure, changing the channel of the image and the like are performed in an operation method different from an existing operation method such as depressing of dedicated buttons.

### BRIEF DESCRIPTION OF DRAWING

FIG. 1 is a diagram illustrating a perspective configuration example of a flexible display according to a first embodiment of the present disclosure.

FIG. 2 is a diagram illustrating a circuit configuration example of the flexible display in FIG. 1.

FIG. 3A is a diagram illustrating that a whole right end of the flexible display in FIG. 1 is bent backward.

FIG. 3B is a diagram illustrating that the whole right end of the flexible display in FIG. 1 is bent forward.

FIG. 4A is a diagram illustrating that an upper right end of the flexible display in FIG. 1 is twisted backward.

FIG. 4B is a diagram illustrating that the upper right end of the flexible display in FIG. 1 is twisted forward.

FIG. 5A is a diagram illustrating that left and right ends of the flexible display in FIG. 1 are bent backward.

FIG. 5B is a diagram illustrating that the left and right ends of the flexible display in FIG. 1 are bent forward.

FIG. 6A is a diagram illustrating that the right end of the flexible display in FIG. 1 is pulled in a right direction.

FIG. 6B is a diagram illustrating that the left and right ends of the flexible display in FIG. 1 are pulled in an outward direction.

FIG. 7A is a diagram illustrating that the right end of the flexible display in FIG. 1 is pushed in a left direction.

FIG. 7B is a diagram illustrating that the left and right ends of the flexible display in FIG. 1 are pushed in an inward direction.

FIG. 8 is a diagram illustrating a circuit configuration example of a pixel in FIG. 2.

FIG. 9 is a diagram illustrating an exploded perspective configuration example of a display panel in FIG. 1.

FIG. 10 is a diagram illustrating a functional block example of a system circuit board in FIG. 1.

FIG. 11 is a diagram illustrating a schematic configuration example of an image display system that includes a flexible remote controller according to a second embodiment of the present disclosure.

FIG. 12 is a diagram illustrating a circuit configuration example of the flexible remote controller in FIG. 11.

FIG. 13 is a diagram illustrating a functional block example of a system circuit board in FIG. 12.

### MODES FOR CARRYING OUT THE INVENTION

Hereinafter, embodiments for practicing the present disclosure are described in detail with reference to the drawings. The following description is a specific example of the present disclosure, but the present disclosure is not limited to the following embodiment. In addition, the present disclosure does not limit the disposition, dimensions, dimension ratios, and the like of respective components illustrated in the drawings thereto. It is to be noted that description is given in the following order.

### 1. First Embodiment (Flexible Display)

### 2. Second Embodiment (Image Display System)

### 1. FIRST EMBODIMENT

### [Configuration]

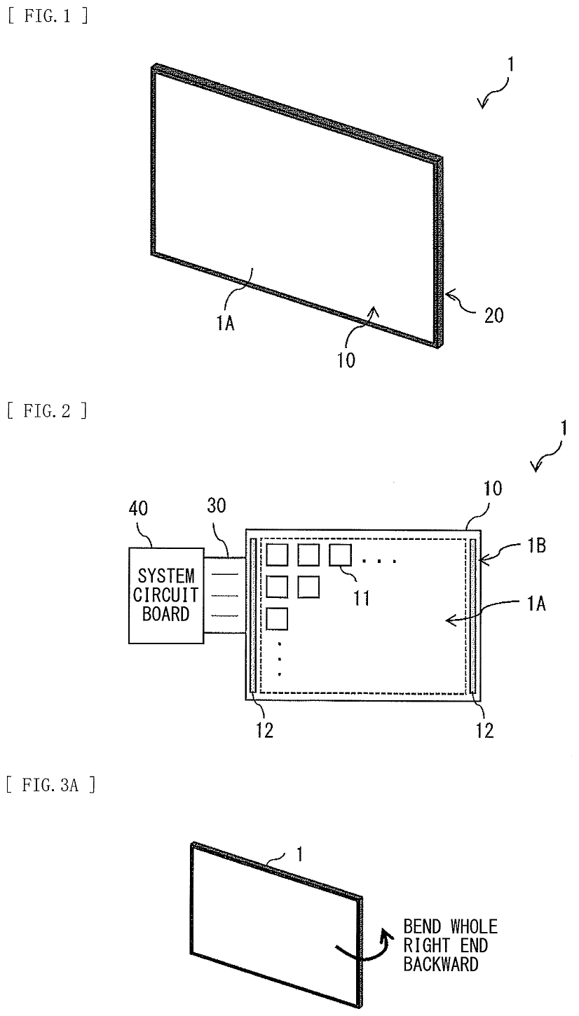

FIG. 1 illustrates, in a perspective manner, a schematic configuration example of a flexible display 1 according to a first embodiment of the present disclosure. FIG. 2 illustrates a circuit configuration example of the flexible display 1. The flexible display 1 corresponds to a specific example of a “display device” in the present disclosure. The flexible display 1 is a thin and flexible self-luminous display that uses an organic EL (electro-luminescence) element called OLED (Organic Light Emitting Diode) for a pixel.

The flexible display 1 has, for example, a display panel 10 having a display region 1A, and a frame 20 that protects an end edge (a peripheral edge of the display region 1A) of the display panel 10. The flexible display 1 further includes, for example, a system circuit board 40 that drives the display panel 10, and FPC (Flexible printed circuits) 30 that electrically couples the display panel 10 and the system circuit board 40.

A plurality of pixels 11 is disposed in a matrix pattern in the display region 1A of the display panel 10. At the end edge (a frame region 1B) of the display panel 10, there is provided an input detector 12 that detects at least one of a bending operation, a pulling operation, or a pushing operation for the display panel 10. The input detector 12 corresponds to a specific example of a “detector” in the present disclosure.

In a case where the input detector 12 detects a bending operation, the input detector 12 includes, for example, a bending sensor. The bending sensor is, for example, an element that generates an electrical potential difference between the upper surface and the lower surface of the bending sensor by being curved as the display panel 10 is curved. The bending sensor is, for example, an EAP (Electroactive Polymer) element that has both the upper and lower surfaces of a polymer compound film interposed between electrode films. The EAP element outputs a voltage correlated with a bending direction and a bending amount. Therefore, in a case where such an EAP element is provided in the display panel 10 as the bending sensor, a voltage correlated with a bending direction and a bending amount of the display panel 10 is outputted from the bending sensor.

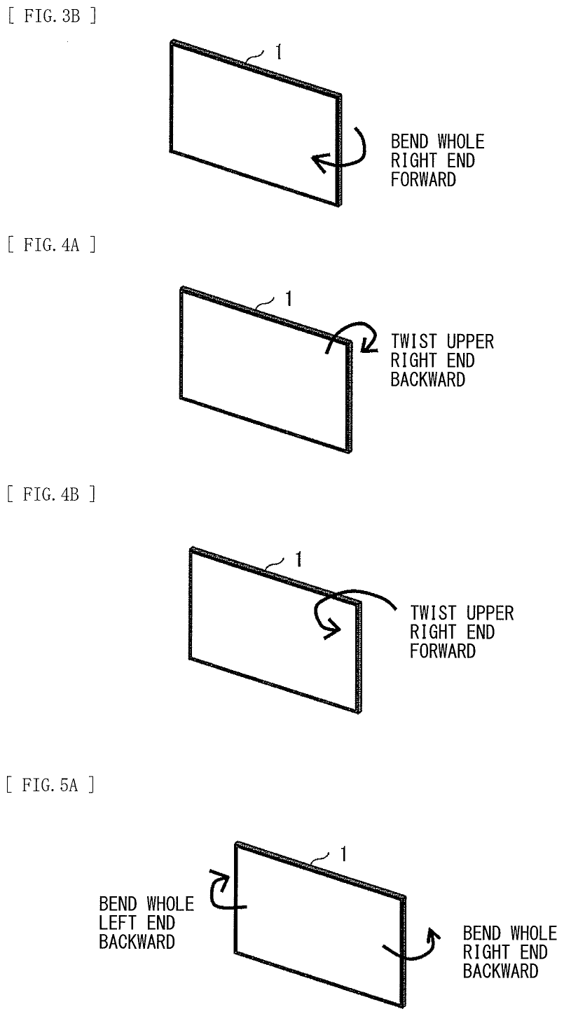

For example, as illustrated in FIG. 3A, in a case where a user bends backward a whole right end of the flexible display 1, signals indicating that the flexible display 1 is curved backward by a predetermined amount are outputted from all the bending sensors provided at the right end of the display panel 10. In addition, for example, as illustrated in FIG. 3B, in a case where a user bends forward the whole right end of the flexible display 1, signals indicating that the flexible display 1 is curved forward by a predetermined amount are outputted from all the bending sensors provided at the right end of the display panel 10.

In addition, for example, as illustrated in FIG. 4A, in a case where a user twists backward only the upper right end of the flexible display 1, signals indicating that the flexible display 1 is curved backward by a predetermined amount are outputted the location corresponding to the upper right end of the display panel 10 from among the bending sensors provided at the right end of the display panel 10. In addition, for example, as illustrated in FIG. 4B, in a case where a user twists forward only the upper right end of the flexible display 1, signals indicating that the flexible display 1 is curved forward by a predetermined amount are outputted the location corresponding to the upper right end of the display panel 10 from among the bending sensors provided at the right end of the display panel 10.

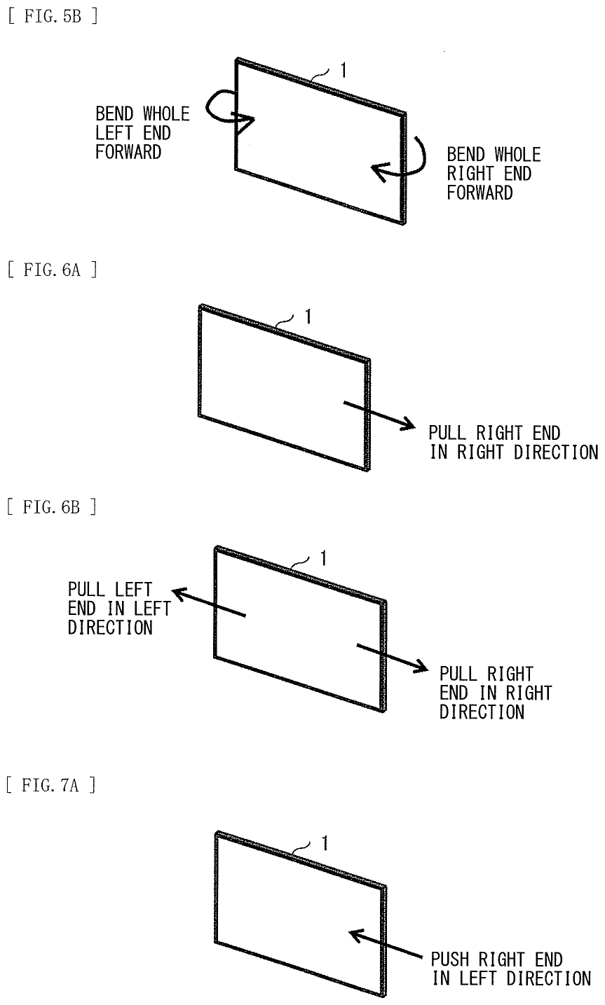

In addition, for example, as illustrated in FIG. 5A, in a case where a user bends backward the whole right end and whole left end of the flexible display 1, signals indicating that the flexible display 1 is curved backward by a predetermined amount are outputted from all the respective bending sensors provided at the right end and left end of the display panel 10. In addition, for example, as illustrated in FIG. 5B, in a case where a user bends forward the whole right end and whole left end of the flexible display 1, signals indicating that the flexible display 1 is curved forward by a predetermined amount are outputted from all the respective bending sensors provided at the right end and left end of the display panel 10.

In a case where the input detector 12 detects a pulling operation, the input detector 12 includes, for example, a piezo element.

For example, as illustrated in FIG. 6A, in a case where a user pulls the right end of the flexible display 1 in the right direction, a signal indicating that the flexible display 1 is pulled in the right direction with a predetermined magnitude is outputted from a location mainly corresponding to a portion in contact with a user hand among the bending sensors provided at the right end of the display panel 10. In addition, for example, as illustrated in FIG. 6B, it is assumed that a user pulls the right end of the flexible display 1 in the right direction, and pulls the left end of the flexible display 1 in the left direction at the same time. In this case, the signal indicating that the flexible display 1 is pulled in the right direction with a predetermined magnitude is outputted from the location mainly corresponding to the portion in contact with the user hand among the bending sensors provided at the right end of the display panel 10. Further, the signal indicating that the flexible display 1 is pulled in the left direction with a predetermined magnitude is outputted from the location mainly corresponding to the portion in contact with the user hand among the bending sensors provided at the left end of the display panel 10.

In a case where the input detector 12 detects a pushing operation, the input detector 12 includes, for example, a piezo element.

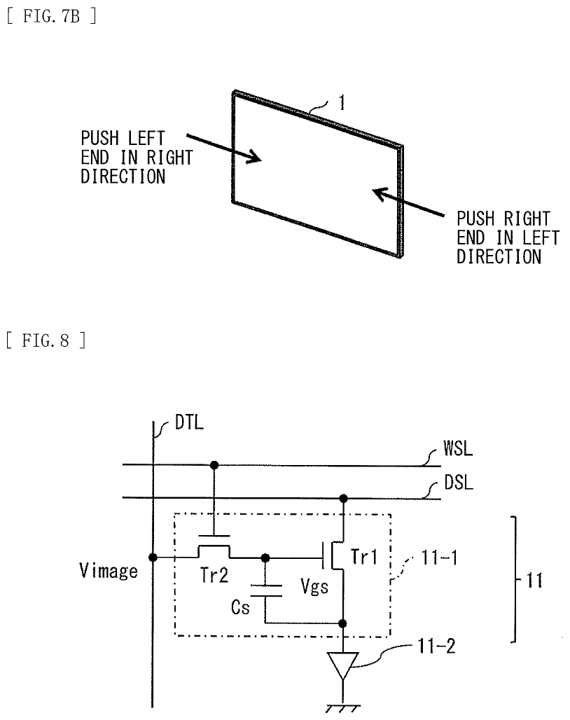

For example, as illustrated in FIG. 7A, in a case where a user pushes the right end of the flexible display 1 in the left direction, a signal indicating that the flexible display 1 is pushed in the left direction with a predetermined magnitude is outputted from a location mainly corresponding to a portion in contact with a user hand among the bending sensors provided at the right end of the display panel 10. In addition, for example, as illustrated in FIG. 7B, it is assumed that a user pushes the right end of the flexible display 1 in the left direction, and pushes the left end of the flexible display 1 in the right direction at the same time. In this case, the signal indicating that the flexible display 1 is pushed in the left direction with a predetermined magnitude is outputted from the location mainly corresponding to the portion in contact with the user hand among the bending sensors provided at the right end of the display panel 10. Further, the signal indicating that the flexible display 1 is pushed in the right direction with a predetermined magnitude is outputted from the location mainly corresponding to the portion in contact with the user hand among the bending sensors provided at the left end of the display panel 10.

FIG. 8 illustrates a circuit configuration example of a pixel 11 of the flexible display 1. The display panel 10 includes, for example, a plurality of gate lines WSL and a plurality of power supply lines DSL that extend in a row direction, as well as a plurality of data lines DTL that extends in a column direction. The pixel 11 is provided in association with an intersection between the data line DTL and the gate line WSL. Each of the data lines DTL, each of the gate lines WSL, and each of the power supply lines DSL are electrically coupled to an output end of the system circuit board 40 through the FPC 30.

The scanning line WSL is used for selection of each of the pixels 11, and supplies each of the pixels 11 with a selection pulse that selects the pixel 11 on a predetermined unit (for example, a pixel row) basis. The signal line DTL is used to supply a signal voltage (a signal voltage Vimage described below) corresponding on an image signal to each of the pixels 11, and supplies a data pulse including the signal voltage Vimage to each of the pixels 11. The power supply line DSL supplies electrical power to each of the pixels 11.

Each of the pixels 11 is, for example, a pixel that emits red light, a pixel that emits green light, or a pixel that emits blue light. It is to be noted that each of the pixels 11 may be further, for example, a pixel that emits another color (for example, white, yellow, or the like). For example, one of the plurality of data lines DTL is assigned to each of pixel columns. For example, one of the plurality of scanning lines WSL is assigned to each of pixel rows. For example, one of the plurality of power supply lines DSL is assigned to each of pixel rows.

Each of the pixels 11 includes a pixel circuit 11-1 and an organic EL element 11-2. The pixel circuit 11-1 controls light emission and light extinction of the organic EL element 11-2. The pixel circuit 11-1 has a function of holding a voltage (the signal voltage Vimage) that is written in each of the pixels 11 by signal writing described below. The pixel circuit 11-1 further has a function of outputting a drive current having a magnitude corresponding to the magnitude of the held voltage to the organic EL element 11-2. The pixel circuit 11-1 includes, for example, a drive transistor Tr1, a write transistor Tr2, and a storage capacitor Cs.

The write transistor Tr2 controls application of the signal voltage Vimage corresponding to an image signal to the gate of the drive transistor Tr1. Specifically, the write transistor Tr2 samples a voltage on the signal line DTL, and writes a voltage obtained from sampling to the gate of the drive transistor Tr1. Writing of the voltage obtained from sampling to the gate of the drive transistor Tr1 is referred to as signal writing. The drive transistor Tr1 is coupled in series to the organic EL element 11-2. The drive transistor Tr1 drives the organic EL element 11-2. The drive transistor Tr1 controls a current flowing in the organic EL element 11-2 in accordance with the magnitude of the voltage sampled by the write transistor Tr2. The storage capacitor Cs holds a predetermined voltage between the gate and source of the drive transistor Tr1. The storage capacitor Cs has a role of keeping constant a voltage Vgs between the gate and source of the drive transistor Tr1 during a predetermined period of time. It is to be noted that the pixel circuit 11-1 may have a circuit configuration in which a variety of capacitors and transistors are added to the 2Tr1C circuit described above, or may have a circuit configuration different from the configuration of the 2Tr1C circuit described above.

The gate of the write transistor Tr2 is coupled to the scanning line WSL. The source or drain of the write transistor Tr2 is coupled to the signal line DTL. A terminal that is uncoupled to the signal line DTL between the source and drain of the write transistor Tr2 is coupled to the gate of the drive transistor Tr1. The source or drain of the drive transistor Tr1 is coupled to the power supply line DSL. A terminal that is uncoupled to the power supply line DSL between the source and drain of the drive transistor Tr1 is coupled to the anode of the organic EL element 11-2. One end of the storage capacitor Cs is coupled to the gate of the drive transistor Tr1. The other end of the storage capacitor Cs is coupled to a terminal on the organic EL element 11-2 side between the source and drain of the drive transistor Tr1.

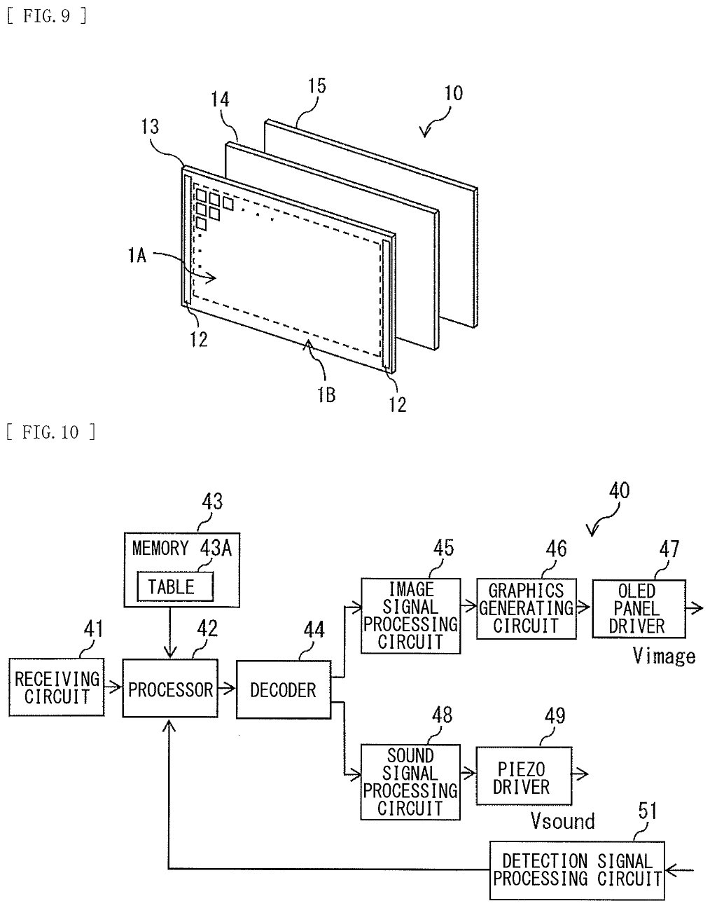

FIG. 9 illustrates an exploded perspective configuration example of the display panel 10. The display panel 10 includes, for example, an OLED panel 13, a heat dissipation film 14 that is disposed on the rear surface side of the OLED panel 13, and a piezo film 15 that is disposed on the rear surface of the heat dissipation film 14. These OLED panel 13, heat dissipation film 14, and piezo film 15 are stacked in this order with, for example, adhesive agents in between.

The OLED panel 13 is a panel that is provided with the display region 1A in which the plurality of pixels 11 is disposed in a matrix pattern, and the frame region 1B including the input detectors 12 on a flexible resin substrate. The heat dissipation film 14 dissipates heat to the outside. The heat is generated in the OLED panel 13 and the piezo film 15. Preferably, the heat dissipation film 14 includes a material that does not prevent the piezo film 15 from oscillating as much as possible. The heat dissipation film 14 includes, for example, a foamed material or a soft resin. The piezo film 15 has a function of an actuator of a speaker. The piezo film 15 is a film in which a piezo element is provided on a flexible resin substrate. The piezo film 15 causes the piezo element to oscillate on the basis of a signal voltage (a signal voltage Vsound described below) corresponding to a sound signal, and transmits the oscillation to the OLED panel 13. Therefore, the OLED panel 13 functions as a flat speaker. It is to be noted that an actuator including a magnetic circuit may be provided in place of the piezo film 15. In addition, in a case where the OLED panel 13 is not used as a flat speaker, a speaker may be provided in place of the piezo film 15.

FIG. 10 is a diagram illustrating a functional block example of a system circuit board 40. The system circuit board 40 causes the display panel 10 to display an image on the basis of a signal inputted from the outside, for example. The system circuit board 40 further causes the display panel 10 to perform any one of changing the channel of the image, turning up the sound volume, turning down the sound volume, muting, displaying the program guide, scaling up the image, scaling down the image, or displaying two screens, for example, on the basis of a detection result obtained by the input detector 12. The processor 42 causes the display panel 10 to perform any one of changing the channel of the image, turning up the sound volume, turning down the sound volume, muting, displaying the program guide, scaling up the image, scaling down the image, or displaying two screens, for example, on the basis of an operation method derived from the detection result obtained by the input detector 12. The processor 42 reads an operation command corresponding to the detection result obtained, for example, by the input detector 12, from a table 43A described below, and causes the display panel 10 to perform any one of changing the channel of the image, turning up the sound volume, turning down the sound volume, muting, displaying the program guide, scaling up the image, scaling down the image, or displaying two screens, on the basis of the read operation command

The system circuit board 40 includes, for example, a receiving circuit 41. The receiving circuit 41 has a configuration corresponding to a kind of signal to be received. For example, in a case where the receiving circuit 41 receives a television broadcast signal, the receiving circuit 41 includes, for example, an antenna terminal, a digital tuner, and a demultiplexer.

The antenna terminal is a terminal to which the television broadcast signal received by a reception antenna (not illustrated) is inputted. The digital tuner processes the television broadcast signal inputted to the antenna terminal, and outputs a predetermined transport stream corresponding to a channel selected by a user, for example. The demultiplexer extracts, for example, partial TS (Transport Stream) corresponding to the channel selected by the user from the transport stream obtained by the digital tuner, and outputs the extracted partial TS to a processor 42.

For example, in a case where the receiving circuit 41 receives an IP (Internet Protocol) signal over the Internet, the receiving circuit 41 receives the IP signal over the Internet to perform, for example, protocol processing that is typical in the IP network for the received IP signal. The receiving circuit 41 further extracts partial TS (Transport Stream) corresponding to the channel selected by the user from the signal subjected to the protocol processing, and outputs the extracted partial TS to the processor 42.

For example, in a case where an operation command corresponding to a detection result obtained by a detection signal processing circuit 51 is inputted from the processor 42, the receiving circuit 41 performs a process corresponding to the inputted operation command for the signal inputted from the outside. For example, it is assumed that the operation command is changing a channel of an image. The receiving circuit 41 then extracts partial TS corresponding to a channel after the change from the signal inputted from the outside, and outputs the extracted partial TS to the processor 42. In addition, for example, it is assumed that the operation command is displaying a program guide. The receiving circuit 41 then extracts partial TS corresponding to a program guide from the signal inputted from the outside, and outputs the extracted partial TS to the processor 42. In addition, for example, it is assumed that the operation command is displaying two screens. The receiving circuit 41 then extracts partial TS corresponding to two channels designated by a control signal inputted to the receiving circuit 41 from the signal inputted from the outside, and outputs the extracted partial TS to the processor 42.

The system circuit board 40 further includes, for example, the processor 42 and a memory 43. The processor 42 controls the operation of each of sections in the flexible display 1. For example, the processor 42 stores the partial TS obtained by the receiving circuit 41 in the memory 43, and transmits the partial TS read from the memory 43 to a decoder 44. For example, the processor 42 reads an operation command corresponding to a sensing result inputted from the detection signal processing circuit 51 from the table 43A described below, and transmits the read operation command to the receiving circuit 41, an image signal processing circuit 45, or a sound signal processing circuit 48.

The memory 43 performs, for example, storage and data management of setting information of the flexible display 1. The memory 43 allows for storage of, for example, the partial TS obtained by the receiving circuit 41.

For example, the memory 43 further stores the table 43A that associates an operation by a user for the flexible display 1 (the display panel 10) with an operation command corresponding to the operation. The table 43A describes, for example, at least one of a bending operation, a pulling operation, or a pushing operation for the flexible display 1 (the display panel 10).

As the bending operation, the table 43A describes, for example, a variety of operations given below.

Operation of bending backward the whole right end of the flexible display 1 (the display panel 10)
Operation of bending backward the whole left end of the flexible display 1 (the display panel 10)
Operation of bending forward the whole right end of the flexible display 1 (the display panel 10)
Operation of bending forward the whole left end of the flexible display 1 (the display panel 10)
Operation of bending backward the whole right end of the flexible display 1 (the display panel 10), and bending backward the whole left end of the flexible display 1 (the display panel 10) at the same time
Operation of bending forward the whole right end of the flexible display 1 (the display panel 10), and bending forward the whole left end of the flexible display 1 (the display panel 10) at the same time

As the pulling operation, the table 43A describes, for example, a variety of operations given below.

Operation of pulling the right end of the flexible display 1 (the display panel 10) in the right direction
Operation of pulling the left end of the flexible display 1 (the display panel 10) in the left direction
Operation of pulling the right end of the flexible display 1 (the display panel 10) in the right direction, and pulling the left end of the flexible display 1 (the display panel 10) in the left direction at the same time

As the pushing operation, the table 43A describes, for example, a variety of operations given below.

Operation of pushing the right end of the flexible display 1 (the display panel 10) in the left direction
Operation of pushing the left end of the flexible display 1 (the display panel 10) in the right direction
Operation of pushing the right end of the flexible display 1 (the display panel 10) in the left direction, and pushing the left end of the flexible display 1 (the display panel 10) in the right direction at the same time

The table 43A describes, for example, the following operation commands corresponding to the various operations described above. An operation command sometimes describes an adjustment amount corresponding to the amount of operation for the flexible display 1 (the display panel 10). For example, the table 43A describes the number of channel skips, the turning-up amount of a sound volume, the turning-down amount of a sound volume, the scaling-up ratio of an image, or the scaling-down ratio of an image corresponding to the amount of operation for the flexible display 1 (the display panel 10).

Changing a channel of an image
Turning up a sound volume
Turning down a sound volume

### Muting

Displaying a program guide
Scaling up an image
Scaling down an image
Displaying two screens

The system circuit board 40 further includes, for example, the decoder 44, the image signal processing circuit 45, a graphics generating circuit 46, an OLED panel driver 47, the sound signal processing circuit 48, a piezo driver 49, and the detection signal processing circuit 51.

The decoder 44 performs a decoding process, for example, on an image PES (Packetized Elementary Stream) packet included in the partial TS obtained by the receiving circuit 41 to obtain image data. The decoder 44 also performs a decoding process, for example, on a sound PES packet included in the partial TS obtained by the receiving circuit 41 to obtain sound data.

The image signal processing circuit 45 and the graphics generating circuit 46 perform, for example, multi-image processing, graphics data superimposition processing, and the like on the image data obtained by the decoder 44 as necessary.

The image signal processing circuit 45 performs a predetermined process on the image data, and outputs the image data subjected to the predetermined process to the graphics generating circuit 46. For example, in a case where an operation command corresponding to a detection result obtained by a detection signal processing circuit 51 is inputted from the processor 42, the image signal processing circuit 45 performs a process corresponding to the inputted operation command for the image signal. The image signal processing circuit 45 outputs the image data subjected to the process corresponding to the operation command inputted from the processor 42 to the graphics generating circuit 46.

For example, it is assumed that the operation command is scaling up an image. The image signal processing circuit 45 then performs a process of scaling up an image on the image data, and outputs the image data subjected to the scaling-up process to the graphics generating circuit 46. For example, it is assumed that the operation command is scaling down an image. The image signal processing circuit 45 then performs a process of scaling down an image on the image data, and outputs the image data subjected to the scaling-down process to the graphics generating circuit 46. For example, it is assumed that the operation command is displaying two screens. The image signal processing circuit 45 then performs a process of setting one of two kinds (for example, two channels) of image data inputted from the decoder 44 as a background image, and setting the other as a wipe image, and outputs the image data in which the wipe image is overlaid at a predetermined position on the background image to the graphics generating circuit 46.

The graphics generating circuit 46 generates a UI (User Interface) screen used for screen display, for example. The OLED panel driver 47 drives the OLED panel 13 on the basis of the image data outputted from the graphics generating circuit 46, for example.

The sound signal processing circuit 48 performs a process such as, for example, D/A conversion for sound data obtained by the decoder 44. For example, in a case where an operation command corresponding to a detection result obtained by a detection signal processing circuit 51 is inputted from the processor 42, the sound signal processing circuit 48 performs a process corresponding to the inputted operation command for the sound signal. The piezo driver 49 amplifies, for example, the sound signal subjected to the process corresponding to the operation command inputted from the processor 42, and supplies the amplified sound signal to the piezo film 15.

For example, it is assumed that the operation command is turning up a sound volume. The sound signal processing circuit 48 then performs a process of turning up the sound volume for sound data, and outputs the sound data in which the sound volume is turned up to the piezo driver 49. In addition, for example, it is assumed that the operation command is turning down a sound volume. The sound signal processing circuit 48 then performs a process of turning down the sound volume for sound data, and outputs the sound data in which the sound volume is turned down to the piezo driver 49. In addition, for example, it is assumed that the operation command is muting. The sound signal processing circuit 48 then performs a process of muting the sound volume for sound data, and outputs the muted sound data to the piezo driver 49.

The detection signal processing circuit 51 detects an operation performed by a user for the flexible display 1 on the basis of a detection signal inputted from the input detector 12.

For example, it is assumed that signals indicating that the flexible display 1 is curved backward by a predetermined amount are inputted as detection signals from all the bending sensors provided at the right end of the display panel 10. In this case, the detection signal processing circuit 51 determines that, for example, as illustrated in FIG. 3A, a user performs an operation of bending backward the whole right end of the flexible display 1 by a predetermined amount, and outputs a detection result indicating that the user performs such an operation to the processor 42. In addition, for example, it is assumed that signals indicating that the flexible display 1 is curved forward by a predetermined amount are inputted as detection signals from all the bending sensors provided at the right end of the display panel 10. In this case, the detection signal processing circuit 51 determines that, for example, as illustrated in FIG. 3B, a user performs an operation of bending backward the whole right end of the flexible display 1 by a predetermined amount, and outputs a detection result indicating that the user performs such an operation to the processor 42.

In addition, for example, it is assumed that signals indicating that the flexible display 1 is curved backward by a predetermined amount are inputted as detection signals from the location corresponding to the upper right end of the display panel 10 among the bending sensors provided at the right end of the display panel 10. In this case, the detection signal processing circuit 51 determines that, for example, as illustrated in FIG. 4A, a user performs an operation of twisting backward only the upper right end of the flexible display 1 by a predetermined amount, and outputs a detection result indicating that the user performs such an operation to the processor 42. In addition, for example, it is assumed that signals indicating that the flexible display 1 is curved forward by a predetermined amount are inputted as detection signals from the location corresponding to the upper right end of the display panel 10 among the bending sensors provided at the right end of the display panel 10. In this case, the detection signal processing circuit 51 determines that, for example, as illustrated in FIG. 4B, a user performs an operation of twisting forward only the upper right end of the flexible display 1 by a predetermined amount, and outputs a detection result indicating that the user performs such an operation to the processor 42.

In addition, for example, it is assumed that signals indicating that the flexible display 1 is curved backward by a predetermined amount are inputted as detection signals from all the respective bending sensors provided at the right end and left end of the display panel 10. In this case, the detection signal processing circuit 51 determines that, for example, as illustrated in FIG. 5A, a user performs an operation of bending backward the whole right end and whole left end of the flexible display 1 by a predetermined amount, and outputs a detection result indicating that the user performs such an operation to the processor 42. In addition, for example, it is assumed that signals indicating that the flexible display 1 is curved forward by a predetermined amount are inputted as detection signals from all the respective bending sensors provided at the right end and left end of the display panel 10. In this case, the detection signal processing circuit 51 determines that, for example, as illustrated in FIG. 5B, a user performs an operation of bending forward the whole right end and whole left end of the flexible display 1 by a predetermined amount, and outputs a detection result indicating that the user performs such an operation to the processor 42.

In addition, for example, it is assumed that the signal indicating that the flexible display 1 is pulled with a predetermined magnitude in the right direction is inputted as a detection signal from the location mainly corresponding to the portion in contact with the user hand among the bending sensors provided at the right end of the display panel 10. In this case, the detection signal processing circuit 51 determines that, for example, as illustrated in FIG. 6A, a user performs an operation of pulling the right end of the flexible display 1 with a predetermined magnitude in the right direction, and outputs a detection result indicating that the user performs such an operation to the processor 42.

In addition, for example, it is assumed that the signal indicating that the flexible display 1 is pulled in the right direction with a predetermined magnitude is inputted as a detection signal from the location mainly corresponding to the portion in contact with the user hand among the bending sensors provided at the right end of the display panel 10. Further, it is assumed that the signal indicating that the flexible display 1 is pulled in the left direction with a predetermined magnitude is inputted as a detection signal from the location mainly corresponding to the portion in contact with the user hand among the bending sensors provided at the left end of the display panel 10. In this case, the detection signal processing circuit 51 determines that, for example, as illustrated in FIG. 6B, a user pulls the right end of the flexible display 1 in the right direction, and pulls the left end of the flexible display 1 in the left direction at the same time, and outputs a detection result indicating that the user performs such an operation to the processor 42.

In addition, for example, it is assumed that the signal indicating that the flexible display 1 is pushed with a predetermined magnitude in the left direction is inputted as a detection signal from the location mainly corresponding to the portion in contact with the user hand among the bending sensors provided at the right end of the display panel 10. In this case, the detection signal processing circuit 51 determines that, for example, as illustrated in FIG. 7A, a user pushes the right end of the flexible display 1 in the left direction, and outputs a detection result indicating that the user performs such an operation to the processor 42.

In addition, for example, it is assumed that the signal indicating that the flexible display 1 is pushed with a predetermined magnitude in the left direction is inputted as a detection signal from the location mainly corresponding to the portion in contact with the user hand among the bending sensors provided at the right end of the display panel 10. Further, it is assumed that the signal indicating that the flexible display 1 is pushed with a predetermined magnitude in the right direction is inputted as a detection signal from the location mainly corresponding to the portion in contact with the user hand among the bending sensors provided at the left end of the display panel 10. In this case, the detection signal processing circuit 51 determines that, for example, as illustrated in FIG. 7B, a user pushes the right end of the flexible display 1 in the left direction, and pushes the left end of the flexible display 1 in the right direction at the same time, and outputs a detection result indicating that the user performs such an operation to the processor 42. [Effects]

Next, effects of the flexible display 1 according to the present embodiment are described.

To date, in a case of viewing TV broadcasts on a tablet terminal, changing a channel and changing a sound volume have performed using mechanical buttons provided on the terminal, buttons displayed on a screen of the terminal, or the like.

In contrast, the present embodiment allows for at least one of a bending operation, a pulling operation, or a pushing operation for the flexible display 1 (the display panel 10), and an operation for the flexible display 1 (the display panel 10) is detected by the input detector 12. Further, any one of changing the channel of the image, turning up the sound volume, turning down the sound volume, muting, displaying the program guide, scaling up the image, scaling down the image, or displaying two screens is performed by the flexible display 1 (the display panel 10) on the basis of the detection result obtained by the input detector 12. In such a manner, in the present embodiment, changing the channel of the image and the like are performed in an operation method different from an existing operation method such as depressing of dedicated buttons. This allows the flexible display 1 to provide a new interface.

In addition, in the present embodiment, any one of changing the channel of the image, turning up the sound volume, turning down the sound volume, muting, displaying the program guide, scaling up the image, scaling down the image, or displaying two screens is performed by the flexible display 1 (the display panel 10) on the basis of an operation method detected by the input detector 12. In such a manner, in the present embodiment, changing the channel of the image and the like are performed in an operation method different from an existing operation method such as depressing of dedicated buttons. This allows the flexible display 1 to provide a new interface.

In addition, in the present embodiment, an operation command corresponding to the operation method detected by the input detector 12 is read from the table 43A, and any one of changing the channel of the image, turning up the sound volume, turning down the sound volume, muting, displaying the program guide, scaling up the image, scaling down the image, or displaying two screens is performed by the flexible display 1 (the display panel 10) on the basis of the read operation command. In such a manner, in the present embodiment, changing the channel of the image and the like are performed in an operation method different from an existing operation method such as depressing of dedicated buttons. This allows the flexible display 1 to provide a new interface.

### 2. SECOND EMBODIMENT

### [Configuration]

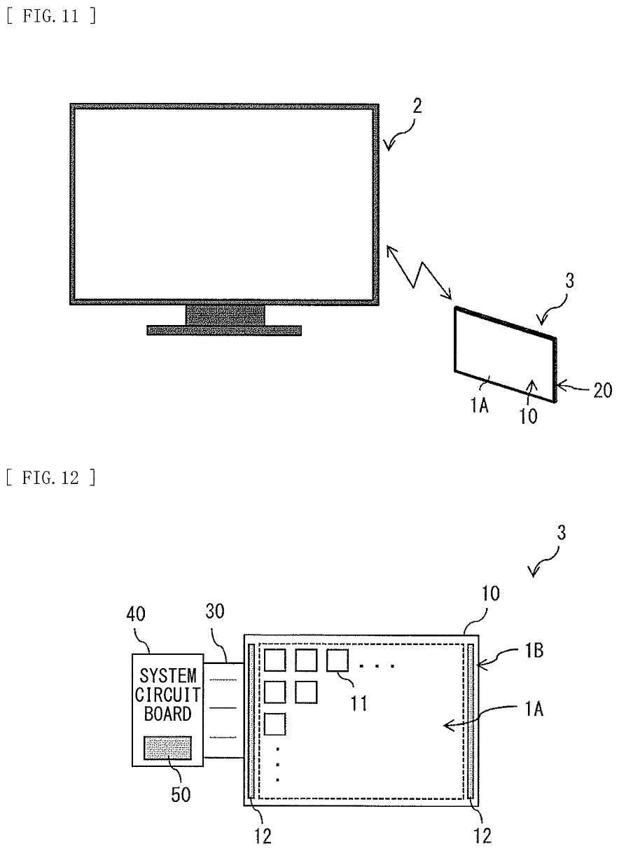

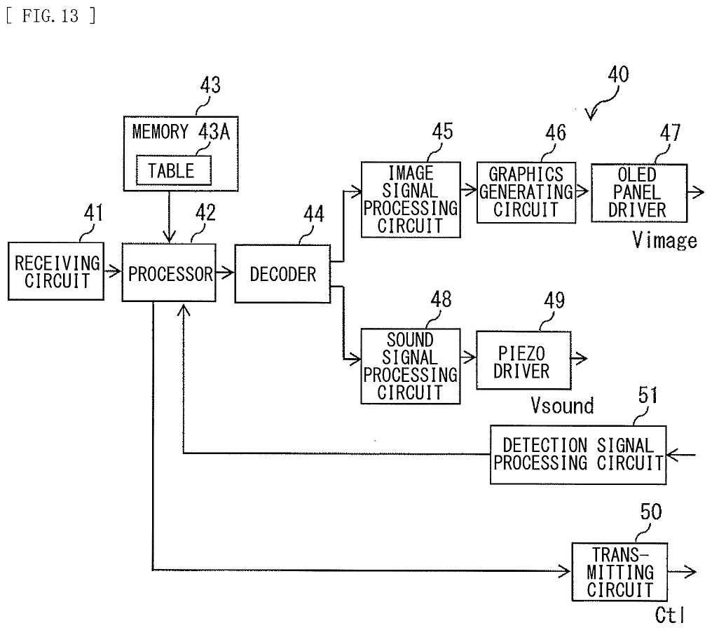

Next, an image display system that includes a flexible remote controller 3 according to a second embodiment of the present disclosure is described. FIG. 11 illustrates a schematic configuration example of the image display system that includes the flexible remote controller 3. FIG. 12 illustrates a circuit configuration example of the flexible remote controller 3. FIG. 13 illustrates a functional block example of the system circuit board 40 included in the flexible remote controller 3.

The image display system includes a stationary display 2 and the flexible remote controller 3 that is able to communicate with the display 2. The display 2 corresponds to a specific example of an “external device” in the present disclosure. The flexible remote controller 3 transmits a predetermined operation command to the display 2 through near-field wireless communication. The flexible remote controller 3 corresponds to the flexible display 1 according to the above-described embodiment that is further provided with a transmitting circuit 50 which is able to perform the near-field wireless communication with the display 2.

The system circuit board 40 causes the display panel 10 to display an image on the basis of a signal inputted from the outside, for example. The system circuit board 40 further causes the display 2 to perform any one of changing the channel of the image, turning up the sound volume, turning down the sound volume, muting, displaying the program guide, scaling up the image, scaling down the image, or displaying two screens, for example, on the basis of a detection result obtained by the input detector 12. The processor 42 causes the display 2 to perform any one of changing the channel of the image, turning up the sound volume, turning down the sound volume, muting, displaying the program guide, scaling up the image, scaling down the image, or displaying two screens, for example, on the basis of an operation method derived from the detection result obtained by the input detector 12. The processor 42 reads an operation command corresponding to the detection result obtained, for example, by the input detector 12, from the table 43A, and causes the display 2 to perform any one of changing the channel of the image, turning up the sound volume, turning down the sound volume, muting, displaying the program guide, scaling up the image, scaling down the image, or displaying two screens, on the basis of the read operation command. The processor 42 controls the operation of each section in the flexible remote controller 3. For example, the processor 42 reads an operation command corresponding to a sensing result inputted from the detection signal processing circuit 51 from the table 43A, and transmits the read operation command to the transmitting circuit 50.

In the flexible remote controller 3, the system circuit board 40 further has the transmitting circuit 50. On receiving an operation command generated by the processor 42, the transmitting circuit 50 transmits the received operation command to the display 2 as a control signal Ct1. In the present embodiment, the processor 42 transmits the operation command to the display 2 through the transmitting circuit 50, thereby causing the display 2 to perform any one of changing the channel of the image, turning up the sound volume, turning down the sound volume, muting, displaying the program guide, scaling up the image, scaling down the image, or displaying two screens. In the present embodiment, the processor 42 causes also the display panel 10 to perform the operation that the display 2 is caused to perform. [Effects]

The present embodiment allows for at least one of a bending operation, a pulling operation, or a pushing operation for the flexible remote controller 3 (the display panel 10), and an operation for the flexible remote controller 3 (the display panel 10) is detected by the input detector 12. Further, any one of changing the channel of the image, turning up the sound volume, turning down the sound volume, muting, displaying the program guide, scaling up the image, scaling down the image, or displaying two screens is performed by the display 2 on the basis of the detection result obtained by the input detector 12. In such a manner, in the present embodiment, changing the channel of the image and the like are performed in an operation method different from an existing operation method such as depressing of dedicated buttons. This allows the flexible remote controller 3 to provide a new interface.

In addition, in the present embodiment, the flexible remote controller 3 is also caused to perform the operation that the display 2 is caused to perform. In such a manner, in the present embodiment, changing the channel of the image and the like are performed in an operation method different from an existing operation method such as depressing of dedicated buttons. This allows the flexible remote controller 3 to provide a new interface.

In addition, in the present embodiment, any one of changing the channel of the image, turning up the sound volume, turning down the sound volume, muting, displaying the program guide, scaling up the image, scaling down the image, or displaying two screens is performed by the flexible remote controller 3 (the display panel 10) on the basis of an operation method detected by the input detector 12. In such a manner, in the present embodiment, changing the channel of the image and the like are performed in an operation method different from an existing operation method such as depressing of dedicated buttons. This allows the flexible remote controller 3 to provide a new interface.

In addition, in the present embodiment, an operation command corresponding to the operation method detected by the input detector 12 is read from the table 43A, and any one of changing the channel of the image, turning up the sound volume, turning down the sound volume, muting, displaying the program guide, scaling up the image, scaling down the image, or displaying two screens is performed by the display 2 on the basis of the read operation command. In such a manner, in the present embodiment, changing the channel of the image and the like are performed in an operation method different from an existing operation method such as depressing of dedicated buttons. This allows the flexible remote controller 3 to provide a new interface.

It is to be noted that, in the present embodiment, the flexible remote controller 3 may not be caused to perform the operation that the display 2 is caused to perform. In addition, in the present embodiment, the display panel 10 may not be provided with a sound output device (for example, the piezo film 15 or the like). Even in such a case, it is possible to obtain an effect similar to that of the above-described second embodiment.

Although the present disclosure has been described with reference to a plurality of embodiments, the present disclosure is not limited to these embodiments, and may be modified in a variety of ways. It is to be noted that the effects described herein are merely illustrative. The effects of the present disclosure are not limited to the effects described herein. The present disclosure may have effects other than the effects described herein.

In addition, for example, it is possible to configure the present disclosure as follows.

(1)

A display device including:

a display panel that is flexible;

a detector that is provided at an end edge of the display panel, and detects at least one of a bending operation, a pulling operation, or a pushing operation for the display panel; and

a controller that causes the display panel to display an image, and causes the display panel to perform any one of changing a channel of the image, turning up a sound volume, turning down the sound volume, muting, displaying a program guide, scaling up the image, scaling down the image, or displaying two screens, on the basis of a detection result obtained by the detector.

(2)

The display device according to (1), in which the controller causes the display panel to perform any one of changing the channel of the image, turning up the sound volume, turning down the sound volume, muting, displaying the program guide, scaling up the image, scaling down the image, or displaying the two screens, on the basis of an operation method detected by the detector.

(3)

The display device according to (1) or (2), further including a storage section that stores a table in which an operation for the display panel is associated with an operation command corresponding to the operation, in which

the controller reads the operation command corresponding to the operation method detected by detector from the table in the storage section, and causes the display panel to perform any one of changing the channel of the image, turning up the sound volume, turning down the sound volume, muting, displaying the program guide, scaling up the image, scaling down the image, or displaying the two screens, on the basis of the read operation command

(4)

A mobile terminal including:

a display panel that is flexible;

a detector that is provided at an end edge of the display panel, and detects at least one of a bending operation, a pulling operation, or a pushing operation for the display panel; and

a controller that causes an external device to display an image, and causes the display panel to perform any one of changing a channel of the image, turning up a sound volume, turning down the sound volume, muting, displaying a program guide, scaling up the image, scaling down the image, or displaying two screens, on the basis of a detection result obtained by the detector.

(5)

The mobile terminal according to (4), in which the controller also causes the display panel to perform an operation that the external device is caused to perform.

(6)

The mobile terminal according to (4) or (5), in which the controller causes the external device to perform any one of changing the channel of the image, turning up the sound volume, turning down the sound volume, muting, displaying the program guide, scaling up the image, scaling down the image, or displaying the two screens, on the basis of an operation method detected by the detector.

(7)

The mobile terminal according to any one of (4) to (6), further including a storage section that stores a table in which an operation for the display panel is associated with an operation command corresponding to the operation, in which

the controller reads the operation command corresponding to the operation method detected by detector from the table in the storage section, and causes the external device to perform any one of changing the channel of the image, turning up the sound volume, turning down the sound volume, muting, displaying the program guide, scaling up the image, scaling down the image, or displaying the two screens, on the basis of the read operation command

The display device and the mobile terminal according to the respective embodiments of the present disclosure each perform changing a channel of an image and the like in an operation method different from an existing operation method such as depressing dedicated buttons, which makes it possible to provide a new interface. It is to be noted that the effects of the present disclosure are not necessarily limited to the effects described here, but may include any of the effects described herein.

This application claims the benefit of Japanese Priority Patent Application JP2017-235530 filed with Japan Patent Office on Dec. 7, 2017, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A display device comprising:
a display panel that is flexible;
a detector that is provided at an end edge of the display panel, and detects at least one of a bending operation, a pulling operation, or a pushing operation for the display panel; and
a controller that causes the display panel to display an image, and causes the display panel to perform any one of changing a channel of the image, turning up a sound volume, turning down the sound volume, muting, displaying a program guide, scaling up the image, scaling down the image, or displaying two screens, on a basis of a detection result obtained by the detector.

2. The display device according to claim 1, wherein the controller causes the display panel to perform any one of changing the channel of the image, turning up the sound volume, turning down the sound volume, muting, displaying the program guide, scaling up the image, scaling down the image, or displaying the two screens, on a basis of an operation method detected by the detector.

3. The display device according to claim 2, further comprising a storage section that stores a table in which an operation for the display panel is associated with an operation command corresponding to the operation, wherein
the controller reads the operation command corresponding to the operation method detected by detector from the table in the storage section, and causes the display panel to perform any one of changing the channel of the image, turning up the sound volume, turning down the sound volume, muting, displaying the program guide, scaling up the image, scaling down the image, or displaying the two screens, on a basis of the read operation command.

4. A mobile terminal comprising:
a display panel that is flexible;
a detector that is provided at an end edge of the display panel, and detects at least one of a bending operation, a pulling operation, or a pushing operation for the display panel; and
a controller that causes an external device to display an image, and causes the display panel to perform any one of changing a channel of the image, turning up a sound volume, turning down the sound volume, muting, displaying a program guide, scaling up the image, scaling down the image, or displaying two screens, on a basis of a detection result obtained by the detector.

5. The mobile terminal according to claim 4, wherein the controller also causes the display panel to perform an operation that the external device is caused to perform.

6. The mobile terminal according to claim 4, wherein the controller causes the external device to perform any one of changing the channel of the image, turning up the sound volume, turning down the sound volume, muting, displaying the program guide, scaling up the image, scaling down the image, or displaying the two screens, on a basis of an operation method detected by the detector.

7. The mobile terminal according to claim 6, further comprising a storage section that stores a table in which an operation for the display panel is associated with an operation command corresponding to the operation, wherein
the controller reads the operation command corresponding to the operation method detected by detector from the table in the storage section, and causes the external device to perform any one of changing the channel of the image, turning up the sound volume, turning down the sound volume, muting, displaying the program guide, scaling up the image, scaling down the image, or displaying the two screens, on a basis of the read operation command.
